(19) United States
(12) Patent Application Publication
(10) Pub. No.: US 2014/0058894 A1
(43) Pub. Date: Feb. 27, 2014

(54) METHOD AND SYSTEM FOR LIVE VIDEO ADVICE

(71) Applicant: LivePoint GmbH, Starnberg (DE)

(72) Inventor: Thomas Hohenacker, Starnberg (DE)

(73) Assignee: LivePoint GmbH, Starnberg (DE)

(21) Appl. No.: 13/972,658

(22) Filed: Aug. 21, 2013

(30) Foreign Application Priority Data
Aug. 22, 2012 (DE) 102012214902.3

(51) Int. Cl. G06Q 30/06

(52) U.S. Cl. CPC G06Q 30/0613
USPC 705/26.41

(57) ABSTRACT

The invention relates to a method for live video advice for at least one customer using an advice system which comprises at least one customer system having a customer computer, a network as well as a vendor system connected to the customer system over the network, wherein the vendor system comprises a server system and a plurality of adviser systems connected to the server system and each having an adviser computer and a camera, wherein the method comprises the steps:
receiving an advice inquiry from the customer system by the server system transmitted over the network;
selecting one of a plurality of replacement backgrounds which are available on the vendor system by the vendor system, in particular in response to the advice inquiry,
selecting an advice system for the live advice;
taking live video information using the camera of the selected adviser system and replacing the background contained in the taken live video information by the selected replacement background for forming a live adviser video; and
transmitting the live adviser video to the customer system as part of a live video stream over the network.

### RELATED APPLICATIONS

This application claims priority to German Patent Application No 102012214902.3, filed Aug. 22, 2012, the disclosure of which is incorporated herein by reference.

### FIELD OF THE INVENTION

The present invention relates to a method and to a system for the personal advice of at least one customer, in particular for purchase advice with respect to travel or to goods such as motor vehicles, wine, medication, sportswear or fashionwear and the like.

Such personal purchase advice currently usually takes place at business premises of a vendor or entrepreneur such as in a travel agency, in the personal presence of the adviser and of the customer. The requirement of the simultaneous presence in this stationary type of advice is associated with the disadvantage that an adviser is idle when no customer is present at the business premises and that a customer cannot be offered any advice when no adviser is available at the respective business premises. The efficiency of this kind of stationary advice is substantially reduced by the unavoidably occurring discrepancy between the presence of the customers and the availability of the advisers at business premises.

The present invention in contrast relates to a method and to a system for live video advice. This has the advantage that the simultaneous presence of adviser and customer at the same location is not necessary, but that rather a video of the adviser is taken and transmitted live to the customer so that the customer and the adviser can basically each be at any desired location. With such live video advice, it is decisive that a feeling of personal and individual advice is communicated to the customer in an appealing ambience thematically corresponding to the wish of the customer.

Methods and systems are generally known with which a video taken by a camera connected to a computer can be transmitted live to a further computer over a network such as the internet. The known methods and systems are, however, not directly suitable for a use for live video advice since the above-named demands cannot be satisfied. A video taken at a customary computer workplace of an adviser thus does not typically communicate the attractive impression desired for a video transmission and in particular does not provide an ambience suitable for an advice video. The adaptation of the computer workplace of an adviser to the requirements of an appealing video transmission, for example by corresponding furnishings or decoration and/or lighting, is, however, associated with a substantial effort and/or cost.

Even if the computer workplace of an adviser is designed with corresponding backdrops, lighting and similar furnishings in a manner which generally provides an appealing background suitable for a video transmission, there is the problem that the background cannot be flexibly adapted to a current advice inquiry of a customer. To give the customer the feel of personal advice in an ambience corresponding to his inquiry independently of his specific inquiry, a plurality of differently furnished and decorated adviser workplaces would thus be required which correspond to the variety of topics of the expected advice inquiries and which would have to be occupied by advisers so that the implementation of an advice system corresponding to the demands and suitable for the servicing of a plurality of advice topics is associated with high costs or is ultimately even practically impossible.

It is the object of the invention to provide a method and a system for live video advice which ensure access to a plurality of advisers for the customer and which provides the customer with a live video stream for advice in which an adviser selected by the customer is presented in an ambience corresponding to the inquiry of the customer independently of the adviser's location, with the method and the system being able to be realized with low outlay in materials, costs and personnel.

This object is satisfied by a method having the features of claim 1 and by a system having the features of claim 15.

An advice system is used within the framework of the method in accordance with the invention which comprises at least one customer system having a customer computer, a network as well as a vendor system connected to the customer system over the network. The vendor system has a server system and a plurality of adviser systems connected to the server system, with the adviser systems each comprising an adviser computer and a camera. The reception by the server system of an advice inquiry transmitted over the network by the customer system is a component of the method. One of a plurality of replacement backgrounds which are available on or at the vendor system is preferably selected by the vendor system in response to the advice inquiry. An adviser system for the live advice is furthermore selected and live video information is taken by the camera of the identified adviser system. The background contained in the taken live video information is replaced by the selected replacement background to produce a live adviser video. The live adviser video is transmitted over the network to the customer system as part of a live video stream.

In accordance with the invention, the background contained in the original video data taken by the adviser system is replaced by a replacement background using a corresponding video processing, e.g., digital technical software processing, said replacement background being selected by the adviser system, in particular in response to the advice inquiry, to generate the advice video which is transmitted to the customer system in the live stream by the vendor system. The transmitted adviser video consequently shows the adviser against a background which is selected to match the specific inquiry so that an attractive presentation of the adviser against a background corresponding to the expectation of the customer is achieved, and indeed independently of which adviser or which adviser system was selected by the customer from the plurality of adviser systems.

This attractive presentation is achieved independently of the location of the selected adviser and adviser system or the actual background present at the location and contained in the original video information taken by the adviser system so that no special decorative furnishing of the computer workplace comprising the adviser computer is necessary. The adviser is able to provide the advice service practically from any desired location or computer workplace, e.g., from business premises and equally from home. Since the live adviser video shows the adviser right from the start against the replacement background selected specific to the inquiry, there is in this respect no risk that the impression of an unsuitable or even dubious advice situation arises for the customer due to a background not expected by the customer.

Advantageous embodiments of the invention are set forth in the dependent claims, in the description and in the Figures.

Any desired number of advisers or adviser systems and/or customers or customer systems can participate in the method in accordance with the invention. The customer systems can in this respect be arranged distributed as desired location-wise, in particular when the customer systems are connected to the vendor system over the internet or the world wide web. The adviser systems are preferably likewise connected to the server system and optionally to the customer systems over the internet so that the adviser systems can also be distributed as desired location-wise.

In accordance with an advantageous embodiment, an advice system is used which comprises a plurality of customer systems which each have a customer computer and which are connected to the vendor system over the network, with a plurality of different live video streams being simultaneously transmitted to different customer systems by the vendor system. The different live video streams in this respect contain live video information taken by different adviser systems and different replacement backgrounds with which the respective original background of the live video information taken by the respective adviser system has been replaced. Different customers are thus personally advised simultaneously by different advisers within the framework of the method, with each adviser being presented independently of the other adviser systems and customer inquiries against a background which corresponds to the respective inquiry and which may differ from the background which is being used by another adviser or adviser system.

The advice inquiry can comprise one or more part inquires, for example a general advice inquiry which contains an indication of the topic of the desired advice and/or an adviser inquiry with reference to which an adviser system selected by the customer can be identified. A method step which is carried out in response to the advice inquiry, e.g., the selection of the replacement background, can be made in response to one of the part inquiries when the advice inquiry comprises a plurality of part inquiries. The advice inquiry or a part inquiry of the advice inquiry can e.g. comprise an http request which is e.g. directed to a web address of the server system or any other web-based request. At least two part inquiries, and preferably all the part inquiries of the advice inquiry, can form part of the same session, in particular of a client-server session between the customer system and the server system such as an http session, a TCP session or a similar web-based session so that the different part inquiries over the common session can be brought into relation with one another and can be associated with the common advice inquiry.

The adviser system for the live advice is preferably selected by the customer system. The selection of the adviser system can in this respect be made by a user input carried out at the customer system by the customer. The customer system preferably transmits a corresponding adviser inquiry to the vendor system with reference to which the selected adviser system can be identified.

The advice inquiry can, for example, comprise an http request and can generally form the only part inquiry of the advice inquiry, i.e., can be identical to the advice inquiry. The adviser inquiry preferably, however forms one of a plurality of part inquiries of the advice inquiry made during the same web session. The server system preferably continuously monitors the server system as to which adviser systems are available for live advice at the respective current time. The advisers or the adviser systems which generally participate in the method are preferably centrally registered at the server system. On registration, one of a plurality of accounts managed by the server system is preferably associated with each adviser or adviser system and the respective adviser can register the adviser system used by him for the live advice or can log in using said account. A log-out system is equally preferably provided with which the advice systems logged in to the server system can log out again. The server system can thus continuously monitor which adviser systems are currently logged in and are thus available for live advice at any given time.

The advice inquiry can, for example, comprise a general advice inquiry which can be transmitted by the customer system to the server system before an adviser inquiry as described above in time and can be received by it. This general advice inquiry can, for example, be transmitted by the customer using a web browser running on the customer computer and can e.g. comprise the request by the customer system for a live advice web page provided over the internet by the server system.

The live advice web page can, for example, be integrated into the web appearance or the website of the vendor of the live advice such that the live advice web page can be reached via a link such as a hyperlink or via a corresponding web-based link contained on a general web page of the vendor.

The server system preferably transmits availability information or an availability message to the customer system in response to a general advice inquiry of a customer system such as described above which information or message contains an indication of the available adviser systems. The available adviser systems indicated therein are preferably selected by the server system from the total quantity of all adviser systems logged into the system and thus generally available in dependence on predefined criteria. The selection can, for example, take place in dependence on the topic of the desired advice.

Provision is preferably made that the server system determines the topic of the desired advice, and indeed with reference to corresponding information contained in an advice inquiry, or a part inquiry thereof, made to the server system by the customer system. The information relating to the advice topic can, for example, be contained in an http request of the advice inquiry and can e.g. comprise the request for a specific web page or web address relating to the respective advice topic and provided by the server system. The request can, for example, be generated by selecting a web link contained in a general web page provided by the server system and can be transmitted to the server system. The indication relating to the advice topic can in particular be input by the customer in an input mask such as a web form provided by the server system, in particular as part of a web page and can be transmitted to the server system, e.g. as part of an http request.

An association is preferably stored on the server system which indicates which adviser systems offer advice on a specific topic. This information can, for example, be linked to an account and can be transmitted by the advisers to the server system during the registration or log-in procedure. The server system then identifies those available adviser systems which offer advice on this topic and indicates this in the availability information.

A screen display is preferably generated at the customer system in response to the availability information transmitted by the server system in which display the adviser systems indicated in the availability information are shown, with the adviser systems which are available and displayed on the screen preferably being able to be selected by the customer by a user input at the customer system.

The server system can for this purpose transmit image information and/or text information to the customer system as part of the availability information which allows the presentation of a graphical representation of the available adviser systems. This information can, for example, comprise a web page having data in an HTML format or XML format, with the web page being able to comprise additional data or files which are integrated into the web page via the information in the HTML format or XML format and which are linked thereto. The web page can be transmitted to the customer system and can be displayed by a browser of the customer system there.

The transmitted availability information, in particular a corresponding web page, for each available adviser system can contain image data or image files such as JPG files or BMP files which allow a graphical presentation of the available advisers on the screen of the customer, for example as part of a screen presentation of the transmitted website generated by a web browser. The data, which are preferably stored on the server system, for example, can contain a photographic representation of the adviser associated with the respective adviser system. A plurality of images of an adviser can be stored or be available on the server system which show the adviser against different backgrounds, for example, with the server system selecting one of these images and transmitting it to the customer system as part of the availability information. The transmitted image is in this respect preferably suitably selected in dependence on the advice topic. If a replacement background has already been selected at the relevant time, the image can also be selected in dependence on the selected replacement background, for example such that the background in the image corresponds to or is identical with the selected replacement background. The image of the adviser can be generated by the vendor system, e.g. in that a photo of the adviser and a corresponding background image are combined, in particular in response to the advice inquiry or the selection of the replacement background.

The availability information preferably contains a link or other suitable instruction for generating an http request for each available adviser system and the http request can be used on the customer system for generating and transmitting an adviser inquiry identifying the respective adviser system. The link is preferably tied to the information for the graphical representation of the adviser systems so that the graphical representation of each adviser system has the function of a selectable button in the screen display generated on the customer system, with the button being able to be selected or clicked by the customer by an input device such as a computer mouse, whereupon the inquiry is generated or the link is activated and the http request is transmitted.

In a selection step, the vendor system makes a selection from a plurality of replacement backgrounds which are available on or at the provider system at the time of the advice inquiry. The selection of the replacement background in particular takes place in response to the advice inquiry or to a part inquiry of the advice inquiry which can e.g. comprise an http request as described above. The selection of the replacement background in this respect takes place before the start of the live adviser video in the live video stream so that the live adviser video can be provided with the corresponding replacement background right from the start, whereby an attractive presentation of the adviser which meets expectations is achieved from the start with respect to the customer.

The selection of the replacement background can take place in dependence on predefined parameters which preferably at least comprise a portion of the content of the advice inquiry, in particular the advice topic indicated in the advice inquiry or identifiable with reference to the advice inquiry, the identity of the customer system and/or the identity of the adviser or adviser system selected by the customer. The advice topic can be a specific travel destination or a specific category of goods for which advice is desired. The background of the live stream video is correspondingly matched to the expectation of the customer by the selection of the replacement background in dependence on the advice topic.

The selection of the replacement background can also comprise or consist of a replacement background being selected which is suitable at a current time or for a current general topic. For example, a replacement background suitable for the current season can be selected from a plurality of replacement backgrounds reflecting different seasonal topics. The replacement background can equally be selected in dependence on a currently promoted offer, for example to ravel offer or a goods offer, from a plurality of replacement backgrounds reflecting such offers or the replacement background can represent another current promotion from a plurality of available promotion offers. Finally, it can also be a replacement background personally selected, as described below, by the adviser from the plurality of available replacement backgrounds. The activation and thus ultimately the selection of the respective replacement background can also only take place in these cases at that time at which an advice inquiry is received by the vendor system.

The selection of the used replacement background preferably carried out in response to the advice inquiry can take place in a plurality of steps, with preferably one or more of a plurality of possible replacement backgrounds being selected in each step. A selection step can therefore also comprise a part selection comprising a plurality of replacement backgrounds from a larger total quantity of available replacement backgrounds. For example, the selection can take place in a hierarchical multistage selection process during which the number of possible replacement backgrounds is successively restricted in order finally to select a replacement background. In accordance with an embodiment, a preselection is first made in which a part quantity of the available replacement backgrounds is selected which includes one or more replacement backgrounds. A final selection can subsequently be made in which one of the preselected replacement backgrounds is selected which is then used.

The selection of the replacement background from the replacement backgrounds available on the vendor system can be made by the server system, by the selected adviser system or in a cooperation of the server system and the adviser system. A preselection as described above can, for example, be made on the server system and a final selection can be made as described above on the adviser system starting from the preselection. For this purpose, the server system can transmit an indication of the preselected replacement backgrounds to the selected adviser system.

The selection of the replacement backgrounds or a part selection, preselection or final selection as described above can comprise an automatic selection of one or more replacement backgrounds and/or a user input by which one or more replacement backgrounds are selected. In this respect, in particular an automatic preselection can be made, starting from which a final selection is made by a user input. The user input is in this case preferably actuated by an adviser.

An automatic selection takes place by an automatic selection process which determines one or more replacement backgrounds in a predefined dependence on one or more parameters, with the parameters in particular containing information from the advice inquiry such as the advice topic.

A selection carried out by a user input is preferably initiated by an inquiry of a user input generated on the respective system or an input prompt which is preferably generated in response to the advice inquiry. For the purpose of such an inquiry, a screen display can, for example be generated on the respective system which prompts the user—as a rule an adviser—to make a corresponding selection. The taking of the live video information or at least its transmission in the live video stream preferably only starts after a user input has taken place in response to the inquiry so that it is ensured that the live adviser video contains a suitable replacement background.

The inquiry or input prompt can comprise the generation of an image screen display on the adviser system in which information on the advice inquiry such as the advice topic is preferably presented so that the adviser can take account of this information in the selection of the replacement background by a user input.

In accordance with an embodiment, a screen display is generated on the selected adviser system in which a plurality of available replacement backgrounds are shown which can be selected by the adviser on the adviser system by a user input. The representation of the replacement backgrounds can, for example, comprise a graphical reproduction of the respective replacement backgrounds.

The information on the replacement backgrounds selectable on the adviser system can be provided to the adviser system by the server system. The server system for this purpose transmits corresponding information to the adviser system which preferably also includes the information required for a screen display as described above, with the screen display being generated on the adviser system in response to the reception of this information.

The server system can for this purpose transmit image information and/or text information to the adviser system as part of the transmitted information which allows a graphical representation of the selectable replacement backgrounds. The information can, for example, comprise a web page having data in an HTML format or XML format, with the web page being able to comprise additional data or files which are integrated into the web page via the information in the HTML format or XML format and which are linked thereto, such as image data or image files such as JPG or BMP data. For example, an image file can be included for each selectable replacement background which allows a graphical representation of the replacement background as part of the screen display.

The graphical representations of the selectable replacement backgrounds included in the screen display generated on the adviser system preferably each have the function of a button so that the user or adviser can select a replacement background by selecting the respective representation, for example by clicking with a computer mouse. The configuration information underlying this function is preferably included in the information transmitted by the server system with respect to the available replacement backgrounds, for example as part of the web page which contains the representation of the selectable replacement backgrounds. The replacement backgrounds which were selected by the server system within the framework of a preselection as described above are preferably indicated in the information on the selectable replacement backgrounds transmitted to the adviser system by the server system.

In accordance with an embodiment, a selection of the replacement background can also be made on the adviser system which differs from a preselection of the server system, i.e. the preselection can be overwritten by the adviser system, and indeed automatically or by a user input.

The possibility can also be provided of using a user input to set on the server system or adviser system whether an overwriting of the preselection of one or replacement backgrounds carried out by the server system is permitted or not. If an overwriting has not been permitted, no polling of a user input preferably takes place, but a preselected replacement background is rather used. Otherwise, the user is prompted by an input prompt to select the desired replacement background which will then be used. The user preferably also has the possibility of acknowledging the input prompt, whereupon the background preselected by the server system is used.

The actual live advice between the customer system and the adviser system starts subsequent to the selection of the replacement background. In this respect, live video information, that is time-variable image information which can, for example, define sequential individual images of the video, is taken at the adviser system. For this purpose, a webcam or a digital camera or another camera can be used which is able to take video information, preferably digital video information. This camera can be connected in a known manner to the adviser computer e.g. via a USB cable or can be integrated in the adviser computer. The video information contains the image of the adviser who carries out the advice live during the taking and the background against which the adviser is located in the process.

The background included in the taken video image is replaced with the selected replacement background live, i.e. during the running video taking and preferably at least approximately in real time. In this respect, a digital video processing method is preferably used with technical software. The method can comprise a step in which the contour of the adviser or of the person contained in the video image is detected and the image information contained within the contour is cut out. The image information which corresponds to the negative of the detected contour, i.e. the contour of the background included in the taken video image, is then cut out and the cut-out person and the section of the replacement background matching it are combined with one another so that a live adviser video is generated in which the adviser can be seen against the replacement background.

The contour detection carried out in the original live video information preferably comprises a movement recognition in which moving and non-moving regions in the video image are identified, with regions having quickly changing image information being able to be interpreted as moving regions and regions having image information which changes little or only very slowly being able to be interpreted as background regions. In this respect, the information can also be taken into account or utilized in a suitable manner that a contour is expected in the form of a person or of an adviser.

A video stream is generated from the live adviser video thus generated which includes the live adviser video, i.e. such that the image information included in the live adviser video, including the adviser and the replacement background, can be seen in the video image transmitted over the video stream. The video stream is generated live in this process, i.e. during the ongoing taking of the original live video information by the camera of the adviser system and the replacement of its background with the replacement background.

The video image transmitted with the live video stream can include, in addition to the live adviser video, further moving or non-moving image information which can be transmitted with the live video stream and can be displayed at the customer system together with the live adviser video. In this manner, the video image can be enhanced with additional information relevant to the advice such as videos or images of e.g. a travel destination, a hotel or a product or with text information suitable for the advice or even with advertising which is displayed to the customer so that an even more attractive presentation and advice is achieved. The live video image and the additional image information can in this respect be included in different segments of the video image. For example, a rectangular segment can include the live adviser video and a segment surrounding the rectangular segment in an L shape can include the additional image information. A logo of the vendor or operator arranged in the inside of the live adviser video can equally be superimposed on the live adviser video.

A corresponding selection can be made on the adviser system and/or on the server system as to whether and which additional image information is added to the video transmitted by the live video stream.

For example, one or more additional information elements can be selected at the adviser system by a user input of the adviser during the ongoing stream, wherein, in response to the selection of an additional information element) additional information corresponding to the information element is transmitted to the customer system. The additional information is preferably, as described above, integrated live into the video transmitted by the live video stream and is transmitted as additional image information of the streamed live video.

Following the selection of an additional information element, an automatic segmentation of the video image transmitted in the live video stream is preferably carried out such that the live video stream and the added additional information are included in different segments of the video image. The image section of the stream video showing the live adviser video can for this purpose be brought to a suitable size, in particular reduced in size. Information elements can also be deselected on the adviser system, whereupon the transmission of the corresponding additional information in the live stream is ended and a desegmentation of the image can take place which can e.g. include an enlarging of the adviser video in the streamed video.

The streamed live video is preferably displayed on the adviser system during the live stream transmitted to the customer system so that the adviser can see the information presented to the customer. A screen display is preferably generated at the adviser system which comprises at least two separate screen regions, wherein additional information elements which can be selected during the ongoing live stream are displayed in an enhancement screen region and the live video transmitted to the customer system by the live video system is displayed in a stream screen region. It is thereby made possible for the adviser simultaneously to view the stream video and the available additional information elements and thus to enhance the live video in ongoing advice by selection of suitable information elements with corresponding additional data or information.

The selection or the addition of the additional information elements can be carried out, for example, by means of a drag-and-drop process, wherein the information elements are selected in the enhancement region and are then dragged out of the enhancement region into the streaming region with the live stream to select them for the addition to the live stream.

The selectable additional information elements can be shown symbolically in the enhancement screen region or the actual image information to be displayed can be displayed. In accordance with an advantageous embodiment, the additional information elements can be presented as part of a web page, for example using a web browser, and can, for example, comprise images, e.g. JPG images, videos, text and similar integrated into the web page. The enhancement screen region can, for example, include a browser window or a section of a browser window. The enhancement region can provide a browser functionality such that not only additional information elements can be selected for the integration into the video stream by a user input, e.g. using the above-described drag-and-drop process, but it is also possible to navigate in a known manner between different web pages or web page components containing additional information elements. Access to a plurality of additional elements for addition to the live stream is thereby made possible for the adviser and the adviser can request them in a manner known from conventional web surfing. The web pages are preferably provided by the server system.

The adviser can thus surf in the enhancement region of the screen in the usual manner and thus find suitable information elements for the advice in a simple and fast manner during the ongoing advice. A particularly simple realization of the above functionality is achieved when the display is generated in the enhancement screen region by a conventional web browser which has been expanded, for example by a plug-in, by the possibility of initiating the addition of the corresponding information to the live stream by a corresponding selection of the shown additional information elements.

The replacement backgrounds available in the vendor system can, for example, comprise one or more background images, in particular digital images of a format such as JPG or BMP, or one or more background videos, in particular digital background videos, with the images or videos preferably being statically stored on the server system and/or on the adviser system, for example in a database. The available replacement backgrounds can also comprise one or more digital background video streams, i.e. videos whose image data are integrated into the live advice video by a streaming process during the ongoing live advice video, with the background stream being able to be received by a remotely located server. The background stream can be a live stream so that the adviser video is put together live from image data which comprise live image data taken at the adviser system and live image data taken at another location, whereby the appeal of the advice is further increased. The adviser can, for example, be presented against a live image of the holiday location which the customer is interested in independently of the actual location of the adviser.

The live adviser video can be generated by the server system, in which case the adviser system can transmit or stream the live video information taken by its camera continuously to the server system which can carry out the replacement of the background and can generate the live adviser video. The live adviser video can in principle, however, also be generated by the adviser system itself. The replacement background used on the replacement of the background can respectively already be present on the adviser system or server system generating the adviser video or can be transmitted to it by the respective other system. The addition of any additional information, for example in the event of the selection of additional information elements by a user, can likewise take place by the adviser system or by the server system or by a cooperation of both. The adviser system can carry out all the video processing methods or streaming processes or some of the video processing methods or streaming processes carried out by it using a separate video module which uses a processor working independently of the main processor of the adviser computer. In this manner, a high video quality can also be ensured while using an adviser computer which is not configured for carrying out the above steps with the desired quality so that high-quality, and thus appealing advice is also made possible while using such a computer system.

The live video stream can also comprise live audio information, in particular digital live audio information, which is taken together with the live video information at the adviser system, and indeed preferably using a microphone provided at the adviser system. Common streaming processes can be used which allow the simultaneous transmission of audio information and video information in a common stream.

A bilateral live communication allowing a live dialog is preferably carried out between the customer system and the adviser system. For this purpose, a live stream generated by the customer system and having live audio information and/or video information taken at the customer system is preferably transmitted in parallel with the transmission of the live video system from the vendor system to the customer system from the user system to the adviser system, wherein the contained audio information and/or video information can be output to the screen and/or to a loudspeaker of the adviser system. The customer system can for this purpose likewise comprise a camera and/or a microphone. In particular when a television system is used as a customer system as described in the following, the customer can also transmit audio information, preferably digital audio information, to the adviser system and can thereby speak with the adviser via a landline phone or a cell phone separate from the customer system. In this case, the audio information from the adviser system is preferably also transmitted to the customer system as part of the live video stream so that a time offset between the image and the sound of the adviser is avoided at the customer system.

The described advice process is preferably carried out on a web basis. In this respect, the one or more customer systems and/or the adviser systems are preferably connected to the server system over the internet. The server system provides its individual functions described herein in each case preferably in the form of a web service or a web application. The screen displays described herein and generated at the adviser system and/or at the customer system can in this respect preferably be generated using web contents or web pages transmitted by the server system. For example, the live video stream transmitted to the customer system can also be integrated in or linked to a web page of the server system presented at the customer system and can be presented as part of the web page, e.g. in a browser window. The live advice in accordance with the invention with the functions described herein can thus be integrated in a web page and consequently in the general internet site of a vendor, whereby the accessibility and appeal of this advice offer is increased. The streaming processed described herein can be carried out using known digital streaming processes.

The customer systems and adviser systems each comprise a customer computer and adviser compute respectively. In this connection, a computer is to be understood not only as a personal computer—PC—but generally as any suitable digital processing device, in particular with network or internet capability, which is connected to a monitor and preferably also to a camera. The monitor and/or a possible camera can in this respect be integrated together with the processing device in one unit. For example, it can be a mobile terminal such as a smartphone which can be connected to the internet e.g. via GPRS or UMTS and which preferably has an integrated display as the screen and an integrated camera. The method can then be carried out using a mobile operating system such as Google Android or Apple iOS. It can also be a processing unit, preferably with network or internet capability, which is connected to a television screen and which uses the television screen as a monitor, for example for forming a connected TV system. The processing device can in this respect be integrated in a television set with the television screen or can e.g. be externally connected to it in the manner of a set-top box. In this respect, a camera and/or a microphone can be integrated into the television set. The camera can also be externally connected to the television set, for example via an HDMI cable, and in this case preferably has an integrated microphone.

The adviser systems and/or customer systems can use web browsers to represent the corresponding contents and/or to provide its functions described herein. In this respect, one or more plug-ins can be used which expand the web browsers of the adviser systems and/or customer systems to include the additional functions required for carrying out the method described herein. The functions material to the method can also be provided in full or in part by a smartphone application or smartphone app when a smartphone is used as the customer system or adviser system, the app being installed on the smartphone and using a smartphone operating system such as Google Android or Apple iOS. On the use of a television set, in particular of a connected TV system, the functions can also be fully or partly provided by a connected TV application or connected TV app.

The present invention furthermore relates to a system for live video advice for at least on customer. The system comprises:
at least one customer system;
a network; and
a vendor systems which is connected to the customer system over the network.

The vendor system comprises a server system and a plurality of adviser systems which are connected to the server system and which each comprise an adviser computer and a camera connected to the adviser computer. The advice system is configured for carrying out the following steps:
receiving an advice inquiry from the customer system by the server system transmitted over the network;
selecting one of a plurality of replacement backgrounds which are available on the vendor system by the vendor system, in particular in response to the advice inquiry,
selecting an advice system;
taking live video information using the camera of the selected adviser system and replacing the background contained in the taken live video information by the selected replacement background for forming a live adviser video; and
transmitting the live adviser video to the customer system as part of a live video stream over the network.

The advice system in accordance with the invention is preferably configured for carrying out a method in accordance with the invention as described herein. The advantageous embodiments and advantages described herein with respect to the method in accordance with the invention and to the functionalities of the individual components of the advice system thus also represent, where applicable, corresponding advantageous embodiments or advantages of the system in accordance with the invention or of the corresponding components of the system.

In accordance with an embodiment, at least one adviser system comprises a video module which is connected to the adviser computer of the adviser system and which is configured to replace the background contained in the taken live video with the selected replacement background and/or to generate and/or to transmit the live video stream.

### BRIEF DESCRIPTION OF THE DRAWINGS

The present invention will be described in the following purely by way of example with reference to the enclosed Figures. There are shown:

FIG. 1: an advice system for use in a method in accordance with an embodiment of the invention;

FIG. 2: an advice system and a schematic representation of a method in accordance with an embodiment of the invention;

FIG. 3 an exemplary screen display on a customer system;

FIG. 4 an exemplary screen display on a customer system; and

FIG. 5 an exemplary video image of a live video stream.

### DETAILED DISCLOSURE OF THE INVENTION

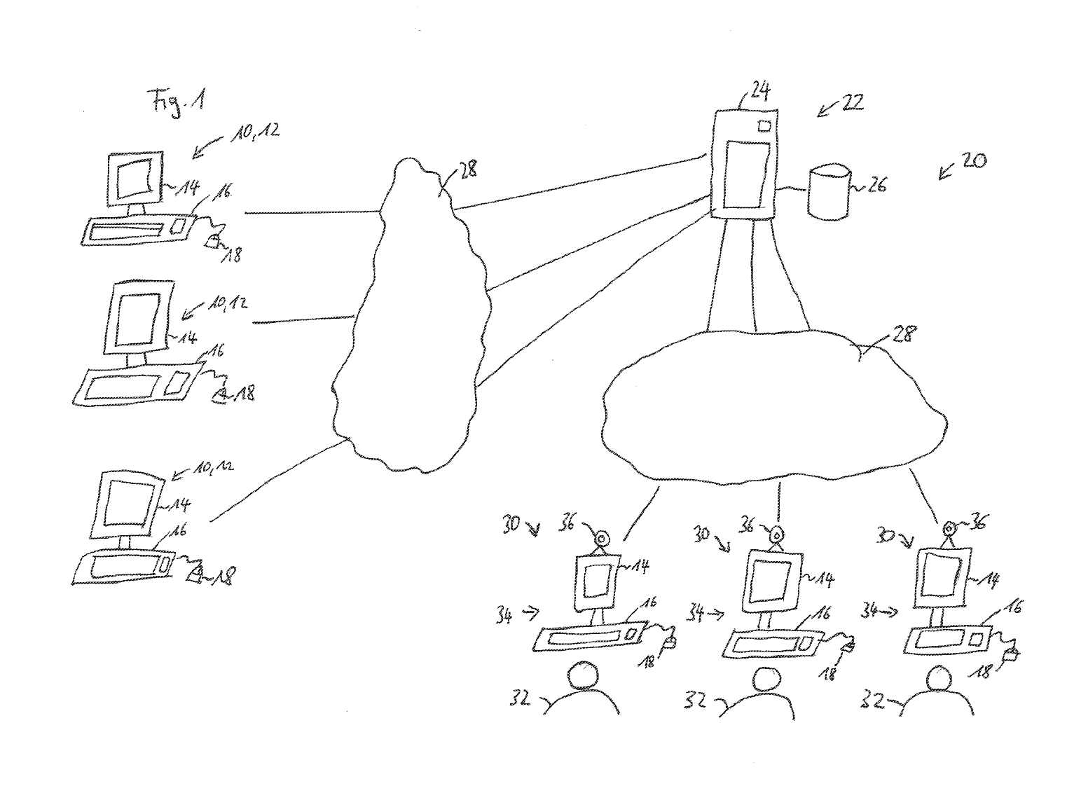

FIG. 1 shows an advice system for use in a method in accordance with an embodiment of the invention. The advice system comprises a plurality of customer systems 10 each having a customer computer 12 which has a monitor 14 and a keyboard 16 and a mouse 18 as input devices. The advice system furthermore comprises a vendor system 20 having a server system 22 which comprises a server computer 24 having a database 26 and which is connected to the customer systems 10 over the internet 28. The vendor system 20 comprises a plurality of adviser systems 30 which are connected to the server system 22 over the internet 28 and which are each occupied by an adviser 32. Each adviser system 30 comprises an adviser computer 34 having a monitor 14 and a keyboard 16 and a mouse 18 as input devices as well as having a camera 36 which is connected to the adviser computer 34 and which is formed in the present case as a web camera and is configured to take digital live video information and to output it continuously to the adviser computer 34.

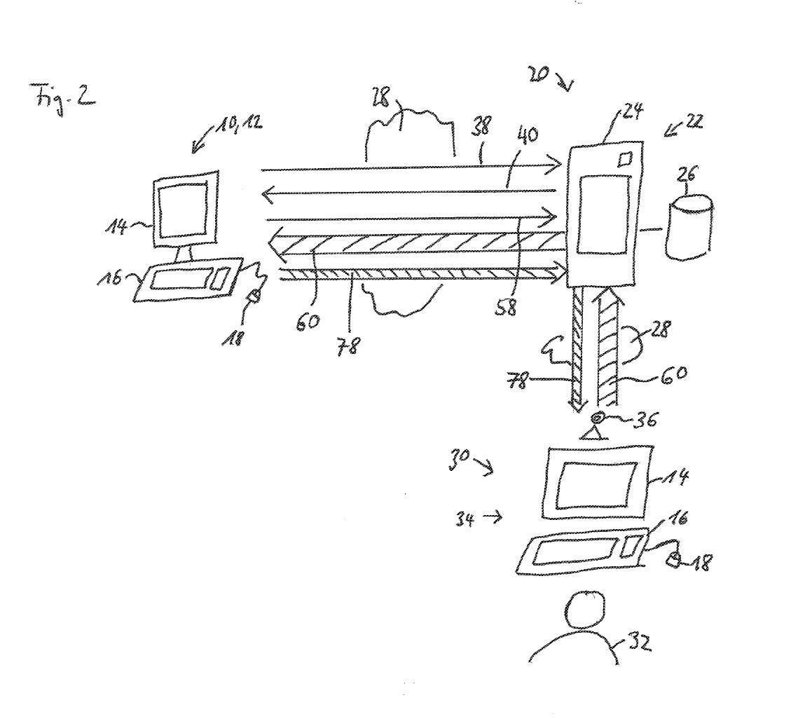

FIGS. 2 to 5 illustrate the procedure of a method for live advice in accordance with an embodiment of the invention. FIG. 2 shows an advice system which substantially corresponds to the advice system shown in FIG. 1, with only a customer system 10 and an adviser system 30 being shown for reasons of clarity.

As shown by a corresponding arrow in FIG. 2, a general advice inquiry 38 is transmitted by the customer system 10 over the internet 28 to the server system 22. The general advice inquiry 38 can, for example, comprise a request actuated via a web browser of the customer system 10 for a web address or web page of the vendor which is provided for the live advice and which is available in or can be requested from the server system 22. The request can be actuated, for example, via a hyperlink or a input into a web form which is contained in a general web page of the server system 22 which is open in the browser of the customer system 10 and which has previously been requested by the customer system 10.

The general advice inquiry 38 comprises an indication of the desired topic of the advice, e.g. in the form that a web page is requested by the customer system 10 by the general advice inquiry 38, which web page is specific to a certain topic such as a specific travel destination.

The server system 22 receives the general advice inquiry 38 and determines with reference to the advice topic the adviser systems 30 which are currently available for live advice on this topic. The server system 22 transmits availability information 40 to the customer system 10 in response to this, which availability information comprises in the present embodiment a web page which corresponds to the general advice inquiry 38 and which comprises data in HTML format or XML format and image data linked thereto. This web page is received by the customer system 10 and the web browser of the customer system 10 generates a screen display with the web page on the screen 14 of the customer system 10.

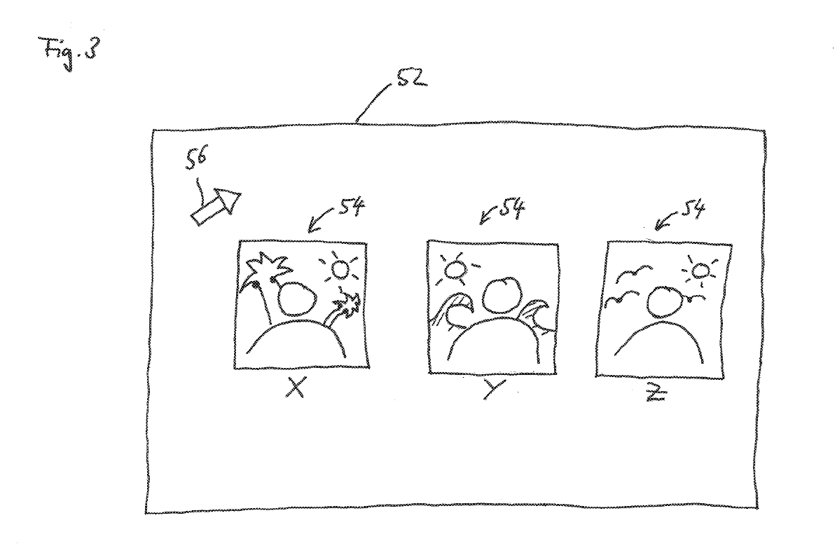

FIG. 3 shows an exemplary screen display 52 with a representation of the web page which is generated by the browser of the customer system 10. The web page comprises data which represent the available adviser systems 30 and which allow a graphical representation thereof in the screen display 52. The web page in this respect contains an image file for each available adviser system 30 which file was selected in dependence on the topic and shows the corresponding adviser 32 against a background corresponding to the topic. The screen display 52 shows the corresponding images 54 for the individual available adviser systems 30 and a representation of a text for each adviser system 30 which is likewise contained on the web page. The mouse cursor 56 is also shown. The customer can move to one of the images 54 with the mouse 18 and click on it to select one of the advisers 32 shown.

The information for the representation of the available adviser systems 30, i.e. in particular the images 54, are linked to corresponding button information on the transmitted web page such that the selection or clicking of an image 54 results in the generation of an adviser inquiry 58 identifying the respective adviser system 30 (FIG. 2), which adviser inquiry is transmitted to the server system 22 and comprises an http request, for example.

In response to the general advice inquiry 38 or to the adviser inquiry 58, one of a plurality of replacement backgrounds available on the vendor system 20 is selected by the vendor system 20, with the information on the available replacement backgrounds being able to be stored in the database 26, for example. This selection can comprise an automatic selection, in particular by the server system 22, or a selection based on a user input, in particular on a user input at the adviser system 30 identified by the adviser inquiry 58, or can comprise a combination of the two.

The advice thereupon starts at the adviser system 30 identified by the adviser inquiry 58, with digital live video information of the adviser 32 being taken with the camera 36 there. The background contained in the taken live video information is replaced with the selected replacement background while using a digital video processing method and the live adviser video which is obtained in this manner and which shows the adviser 32 against the replacement background is transmitted by the vendor system 20 over a live video stream 60 to the customer system 10 where the live adviser video is displayed e.g. in a browser window of the web browser. In addition to the moving live image information, the live adviser video also contains live audio information which is picked up by a microphone at the adviser system 30.

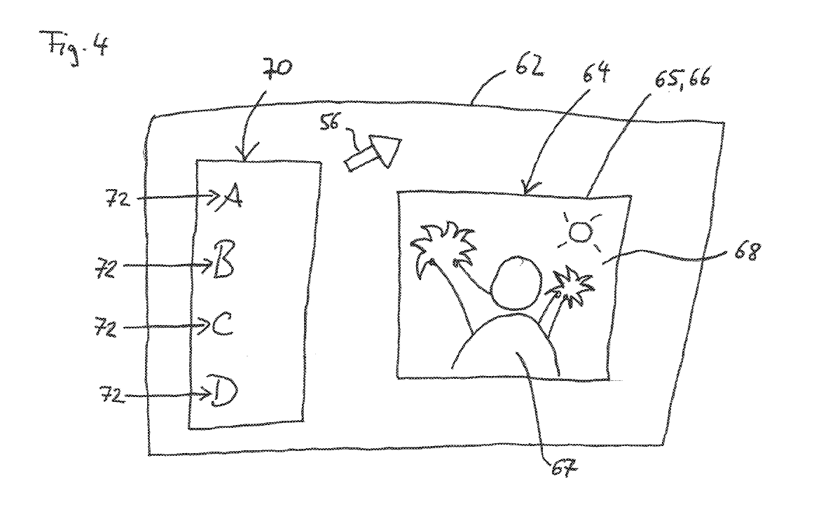

FIG. 4 shows a screen display 62 which is generated at the adviser system 30 during the advice. The screen display 62 comprises two separate regions. On the one hand, a streaming region 64 is provided in which the live video 65 is shown which is transmitted over the live video stream 60 and which in the present case is formed by the live adviser video 65 with the image 67 of the adviser 32 and the selected replacement background 68. On the other hand, an enhancement region 70 is provided in which additional information elements 72 are shown.

The adviser 32 can select one of the information elements 72 via the mouse 18 and can drag it into the streaming region 64 using drag-and-drop to select it for an addition to the live video stream 60. A segmentation of the video image of the live stream 60 is carried out in response to the selection of an information element 72.

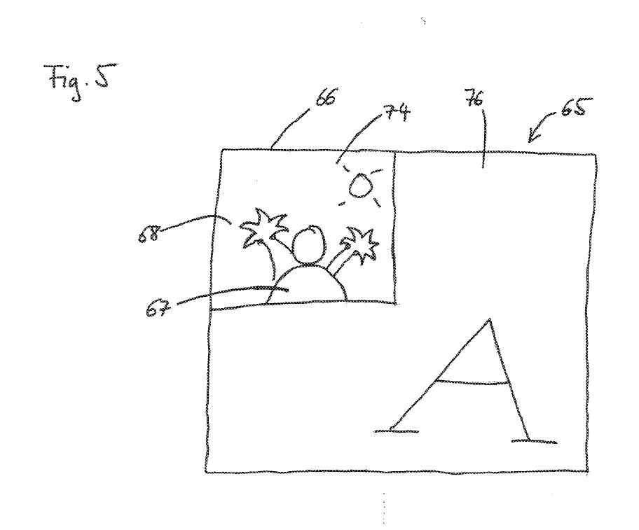

FIG. 5 shows an example live stream video 65 transmitted with the live stream 60 after the segmentation. The video image of the live stream video 65 contains the live adviser video 66 in a rectangular part segment 74. It is surrounded by an L-shaped segment 76 in which image information is shown which corresponds to the selected information element 72.

As shown in FIG. 2, a live video stream and/or a live audio stream 78 is generated at the customer system 10 simultaneously with the live video stream 60 of the vendor system 20 and is transmitted over the server system 22 to the adviser system 30, with the contained image information and/or sound information being able to be output there so that a dialog is made possible between the customer and the adviser 32. Only a pure audio stream 78 is preferably transmitted to the adviser system 30 by the customer system 10 in order thus to have maximum space available for the display of information elements 72 in the screen display 62 of the adviser system 30.

### REFERENCE NUMERAL LIST

10 customer system
12 customer computer
14 screen
16 keyboard
18 mouse
20 vendor system
22 server system
24 server computer
26 database
28 internet
30 adviser system
32 adviser
34 adviser computer
36 camera
38 general adviser inquiry
40 availability information
52 screen display
54 image
56 mouse cursor
58 adviser inquiry
60 live video stream
62 screen display
64 streaming region
65 live stream video
66 live adviser video
67 image of the adviser
68 replacement background
70 enhancement region
72 information element
74, 76 segment
78 video/audio stream of the customer

1. A method for live video advice for at least one customer using an advice system which comprises at least one customer system (10) having a customer computer (12), a network (28) as well as a vendor system (20) connected to the customer system (10) over the network (28), wherein the vendor system (20) comprises a server system (22) and a plurality of adviser systems (30) connected to the server system (22) and each having an adviser computer (34) and a camera (36), wherein the method comprises the steps:
receiving, by the server system (22), an advice inquiry (38, 58) transmitted by the customer system (10) over the network (28);
selecting one of a plurality of replacement backgrounds (68) which are available on the vendor system (20) by the vendor system (20);
selecting an advice system (30) for the live advice;
taking of live video information by the camera (36) of the selected adviser system (30) and replacing the background contained in the taken live video information by the selected replacement background (68) for forming a live adviser video (66); and
transmitting the live adviser video (66) to the customer system (10) as part of a live video stream (60) over the network (28).

2. The method in accordance with claim 1, wherein the step of selecting one of a plurality of replacement backgrounds (68) which are available on the vendor system (20) by the vendor system (20) is carried out in response to the advice inquiry (38, 58).

3. The method in accordance with claim 1, wherein an advice system is used which comprises a plurality of customer systems (10) which each have a customer computer (12) and which are connected to the vendor system (20) over the network (28),
wherein a plurality of different live video streams (60) are transmitted simultaneously by the vendor system (20) to different customer systems (10), wherein different live video streams (60) contain live video information taken by different adviser systems (30) and different replacement backgrounds (68).

4. The method in accordance with claim 1, wherein the adviser system (30) is selected for the live advice by the customer system (10) and the customer system (10) transmits an adviser inquiry (58) to the vendor system (20) with reference to which the selected adviser system (30) is identifiable.

5. The method in accordance with claim 1, wherein the server system (22) transmits availability information (40) to the customer system (10) in response to the advice inquiry (38, 58), which availability information contains an indication of the available adviser systems (30).

6. The method in accordance with claim 5, wherein a screen display (52) is generated at the customer system (10) in which the available adviser systems (30) are presented, with the available adviser systems (30) being able to be selected by the customer by a user input.

7. The method in accordance with claim 1, wherein the advice inquiry (38, 58) contains an indication of the topic of the desired advice.

8. The method in accordance with claim 7, wherein the replacement background (68) is selected in dependence on the indicated topic.

9. The method in accordance with claim 1, wherein a preselection is first made in which a partial quantity of the available replacement backgrounds (68) is selected and subsequently a final decision is made in which one of the preselected replacement backgrounds (68) is selected.

10. The method in accordance with claim 1, wherein the selection of the replacement backgrounds (68) comprises an automatic selection of one or more replacement backgrounds (68) and/or a user input by which one or more replacement backgrounds (68) are selected.

11. The method in accordance with claim 10, wherein a screen display is generated at the adviser system (30) in which a plurality of available replacement backgrounds (68) are presented which can be selected by the adviser (32) by a user input.

12. The method in accordance with claim 1, wherein one or more additional information elements (72) are selected by a user input at the adviser system (30), wherein, in response to the selection of an additional information element (72), additional information corresponding to the information element (72) is transmitted to the customer system (10).

13. The method in accordance with claim 12, wherein the additional information is integrated into the live stream video (65) transmitted by the live video stream (60).

14. The method in accordance with claim 12, wherein the live stream video (65) transmitted by the live video stream (60) is split into mutually separate image segments (74, 76), wherein
one segment (74) contains the live adviser video (66) and another segment (76) contains the additional information.

15. The method in accordance with claim 1, wherein a screen display (62) is generated at the adviser system (30) which screen display comprises at least two separate screen regions (62, 70), with selectable additional information elements (72) being displayed in an enhancement screen region (70) and the live stream video (65) transmitted to the customer system (10) by the live video stream (60) being displayed in a streaming screen region (64).

16. The method in accordance with claim 1, wherein the available replacement backgrounds (68) comprise one or more background images, one or more background videos and/or one or more background live streams.

17. A system for live video advice for at least one customer, comprising
at least one customer system (10);
a network (28);
a vendor system (20) which is connected to the customer system (10) over the network (28);
wherein the vendor system (20) comprises a server system (22) and a plurality of adviser systems (30) which are connected to the server system (22) and which each comprise an adviser computer (34) and a camera (36) connected to the adviser computer (34);
wherein the adviser system is configured for carrying out the following steps:
receiving, by the server system (22), an advice inquiry (38, 58) transmitted by the customer system (10) over the network (28);
selecting one of a plurality of replacement backgrounds (68) which are available on the vendor system (20) by the vendor system (20);
selecting an advice system (30),
taking of live video information by the camera (36) of the selected adviser system (30) and replacing the background contained in the taken live video information by the selected replacement background (68) for forming a live adviser video (66); and
transmitting the live adviser video (66) to the customer system (10) as part of a live video stream (60) over the network (28).

18. The system in accordance with claim 17, wherein the step of selecting one of a plurality of replacement backgrounds (68) which are available on the vendor system (20) by the vendor system (20) takes place in response to the advice inquiry (38, 58).

19. The system in accordance with claim 17, wherein an adviser system (30) comprises a video module which is connected to the adviser computer (34) and which is configured to replace the background contained in the taken live video with the selected replacement background (68) and/or to generate and/or to transmit the live video stream (60).
